(19) United States
(12) Patent Application Publication
(10) Pub. No.: US 2004/0003218 A1
(43) Pub. Date: Jan. 1, 2004

(54) Branch prediction apparatus and branch prediction method

(75) Inventor: Masaki Ukai, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/337,360

(22) Filed: Jan. 7, 2003

(30) Foreign Application Priority Data
Jun. 28, 2002 (JP) 2002-191277

(51) Int. Cl. G06F 9/00

(52) U.S. Cl. 712/240

(57) ABSTRACT

A branch history memory stores the branch history. The branch history represents the results in the past. When processing of a branch instruction is finished, a branch history update section updates the branch history corresponding to the branch instruction, based on the processing result. A branch history table update section updates the branch history in a branch history table. The branch history stores the number of recent continuous branching successful and the number recent of continuous branching failures.

### BACKGROUND OF THE INVENTION

1) Field of the Invention

The present invention relates to a branch prediction apparatus and a branch prediction method, in which a target of a branch instruction is can be predicted with high accuracy and speed, and at low cost.

2) Description of the Related Art

In an information processing apparatus, which adopts a high degree instruction processing method following the pipeline processing method, performance is improved by starting the processing for the subsequent instruction speculatively without waiting for the execution of one instruction.

When a branch instruction is to be executed, however, the instruction address to be executed next cannot be known unless one instruction has been executed, and hence the processing for the subsequent instruction cannot be started. Therefore, attention has been given to a technique in which by predicting an instruction address to be executed next, the processing for the subsequent instruction can be started before executing a branch instruction.

For example, Japanese Patent Application Laid-Open No. H 6-89173 discloses a technique in which an instruction address to be executed next is predicted using a branch history table. According to this technique, branch instruction addresses executed in the past and the target addresses thereof are registered in the branch history table in correlated manner. When a branch instruction registered in the branch history table is to be executed newly, an instruction address to be executed next is predicted using the target address corresponding to the branch instruction.

In order to improve the accuracy in branch prediction, the global history table is also used. The global history stores a plurality of branch histories in the past of each branch instruction, and a branch sequence of a plurality of branch instructions executed immediately before. By using the global history table, a target of a next branch instruction can be predicted based on the regularity of branches in the past, thereby enabling more accurate prediction.

In the global history table, however, it cannot be judged, at the time of registration or update, when the registered or updated branch history or branch sequence is to be referred. Therefore, branch instructions of a number sufficient for the range that can be requested for instruction fetch should be registered, in order to greatly improve the performance with the global history table. However, since there is a limitation in the hardware volume that can be used, due to a limitation in the cost, the number of branch instructions that can be registered is limited. Therefore, a technique is used in which the global history table and the branch history table are used together, so that prediction is carried out based on the global history table with respect to a branch instruction registered in the global history table, and prediction is carried out based on the branch history table with respect to a branch instruction, which has not been registered in the global history.

However, even if the global history table and the branch history table are used together, there is a problem in that the branch instructions that can use high prediction function of the global history table are limited due to a limitation in the cost. Further, the global history table takes time for processing due to complicated prediction processing, and when it is used together with the branch history table, processing time for obtaining one prediction from the both predictions is required, causing a problem in that the instruction fetch request for a predicted target is delayed.

Omission of the registration of the target addresses in the global history table and to predict only the branch direction may be a solution to increase the number of branch instructions registered in the global history table. For example, U.S. Pat. No. 6,055,629 discloses a technique in which a history of branch direction of each branch instruction and sequences of branch directions of a plurality of branch instructions are stored, to thereby predict the branch direction based on the regularity of these. However, in this case, a target address cannot be known until a branch instruction is decoded, and hence fetch of the instruction is delayed, and even if the branch direction can be, accurately predicted, it cannot improve the performance.

### SUMMARY OF THE INVENTION

It is an object of the present invention to provide a branch prediction apparatus and a branch prediction method, which can perform highly accurate prediction at a low cost and at high speed.

The branch prediction apparatus predicts a target of a branch instruction using a branch history table. The branch history table stores a table of correspondence of an address of the branch instruction and a predicted target address of the branch instruction. The branch prediction apparatus has a branch history storage unit that stores a branch history, the branch history containing branching results in the past due to the branch instruction; and a branch history table update unit that predicts a branch direction of the branch instruction based on the branch history stored in the branch history storage unit and updates the table of correspondence based on the predicted branch direction.

The branch prediction method is a method of predicting a target of a branch instruction using a branch history table. The branch history table stores a table of correspondence of an address of the branch instruction and a predicted target address of the branch instruction. The branch prediction method includes a branch history table update step of storing a plurality of branch results of the branch instruction in the past as a branch history, and updating the stored branch history, at a point in time when the processing of the branch instruction has been finished, based on the processing result; and a branch history update step of predicting a branch direction of the branch instruction based on the branch history updated at the branch history update step and updating the table of correspondence based on the predicted branch direction.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a diagram which explains the principle of branch prediction according to an embodiment of the present invention,

FIG. 2 is a functional block diagram which shows the configuration of a branch prediction apparatus shown in FIG. 1,

FIG. 3 is a diagram which shows one example of data structure for entry to a branch history,

FIG. 4 is a diagram which shows one example of data structure for entry to a branch history memory,

FIG. 5A is a diagram which explains Taken, N-Taken, and Current when Curr.Dir is equal to zero and FIG. 5BA is a diagram which explains Taken, N-Taken, and Current when Curr.Dir is equal to one,

FIG. 6 is a flowchart which shows a procedure of branch history update processing by a branch history update section shown in FIG. 2, and

FIG. 7 is a flowchart which shows a procedure of branch history update processing by a branch history update section shown in FIG. 2.

### DETAILED DESCRIPTIONS

An embodiment of the branch prediction apparatus and the branch prediction method according to the present invention will be explained in detail, with reference to the accompanying drawings.

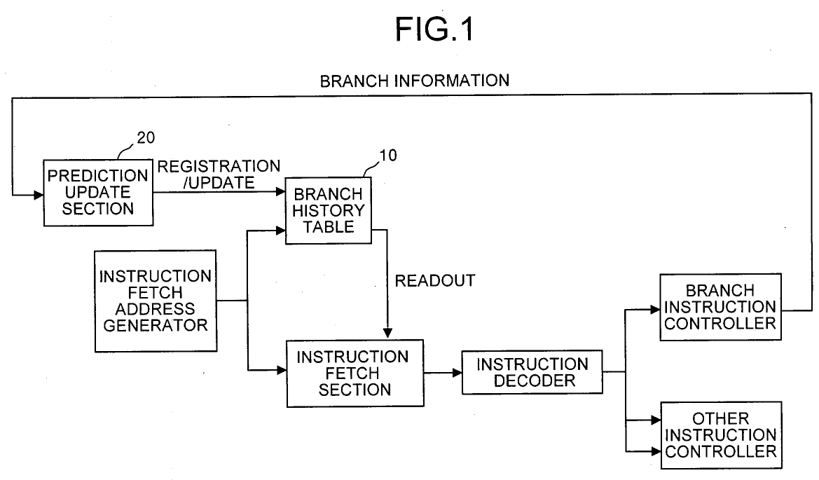

The principle of a branch prediction according to this embodiment will be explained first. FIG. 1 is a diagram which explains the principle of the branch prediction according to this embodiment. An instruction fetch section makes use of an instruction fetch address generated by an instruction fetch address generator to issue an instruction fetch request and also refers to a branch history table 10.

When a branch instruction corresponding to the instruction fetch address has been registered in the branch history table 10, the target instruction address predicted by the branch history table 10 is read out, and the next instruction fetch is carried out based on this instruction address.

The branch instruction fetched is decoded by an instruction decoder, and processed by a branch instruction controller. When the processing of the branch instruction has been completed by the branch instruction controller, branch information such as branching successful or failure is delivered to a prediction update section 20.

The prediction update section 20 stores a branch history of each branch instruction, and updates the branch history of the branch instruction corresponding thereto, using the received branch information. The next branch direction of this branch instruction is predicted based on the updated branch history, and the branch history table 10 is updated based on the predicted branch direction.

The prediction update section 20 does not directly predict a target by using a branch history, as with the global history, but predicts the branch direction by using the branch history, and based on the prediction result, updates the branch history table 10.

Therefore, the prediction update section 20 can reflect the prediction result obtained by using the branch history at the time of branching successful in the branch history table 10. As a result, at the time of requesting instruction fetch, the range where the instruction fetch is to be carried out can be covered with the branch history table 10 having a sufficiently large capacity. Hence, even when the number of branch instructions that can be registered is very small, highly accurate prediction becomes possible, as compared with the global history table, which stores target addresses.

At the time of requesting instruction fetch, only reference to the branch history table 10 is required, and processing for obtaining one prediction from both predictions after referring to the global history table and the branch history table 10 is not required. As a result, the hardware volume can be reduced, and delay of the instruction fetch can be prevented.

The prediction update section 20 can be used without affecting the design of the instruction fetch section, and without changing the conventional prediction mechanism by the branch history table 10.

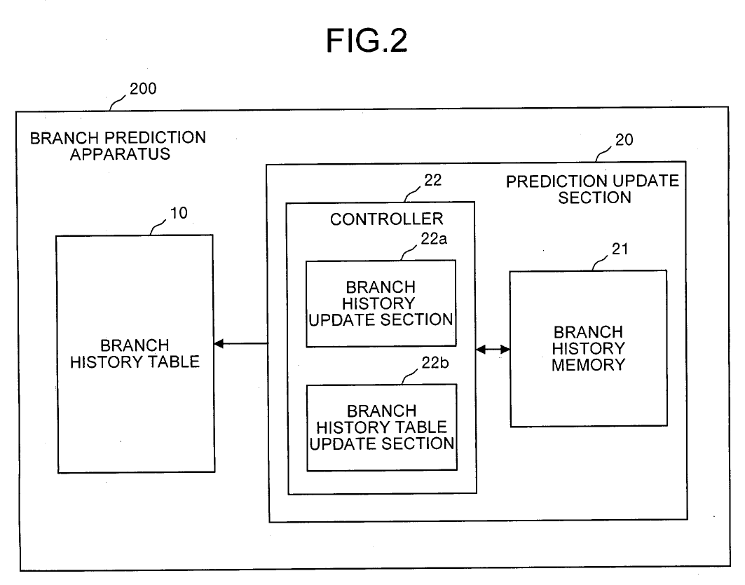

A concrete configuration of the branch prediction apparatus will be explained with reference to FIG. 2. As shown in this figure, a branch prediction apparatus 200 has the branch history table 1 0 and the prediction update section 20.

The branch history table 10 is basically a memory and it stores a branch instruction address and a predicted target address corresponding to each other, for each branch instructions executed in the past. When a branch instruction is included in the instruction data taken out by the instruction fetch section, the branch history table 10 is used for predicting the target address of the branch instruction. This branch history table 10 is an associative memory, and can refer to the predicted target address from the instruction address.

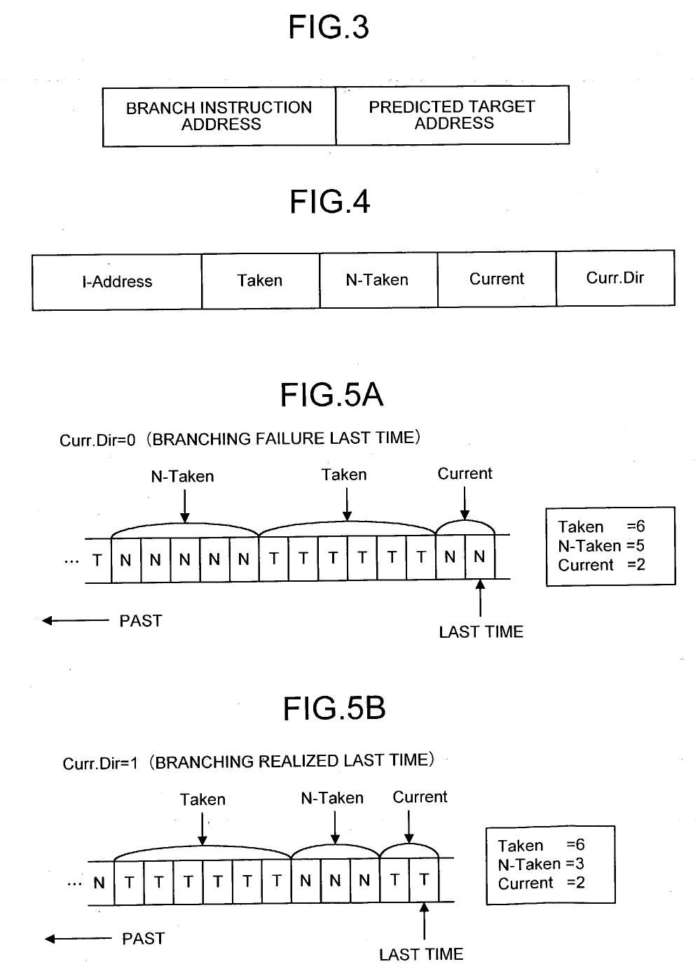

FIG. 3 is a diagram which shows an example of the data structure of the entries of the branch history table 10. The entries in the branch history table 10 include a branch instruction address and a predicted target address.

The branch instruction address is an instruction address of a branch instruction, and is used as a reference to the branch history table 10. The predicted target address is a target address when this branch instruction has been executed in the past, and when this branch instruction is to be executed next, it is used as a predictor of the target address.

In this branch history table 10, only a branch instruction predicted that branch will be realized by the next execution is registered, and a branch instruction predicted that branch will be a failure is not registered.

In contrast, in case of the global history table, it is necessary to register all branch instructions, regardless of the next branch prediction, and similar prediction can be carried out by the branch history table 10, with half the number of entries in the case of the global history table.

The prediction update section 20 predicts the next branch direction based on the branch history of each branch instruction, and updates the branch history table 10 based on the prediction result. The prediction update section 20 has a branch history memory 21 and a controller 22.

The branch history memory 21 is a memory that stores a history of branch direction in the past, for each branch instruction executed in the past. Details of the branch history memory 21 will be described later.

The controller 22 carries out branch prediction by using the branch history memory 21 and updates the branch history table 10 based on the prediction result, and has a branch history update section 22a and a branch history table update section 22b.

The branch history update section 22a updates the branch history in the branch history memory 21 relating to a branch instruction, based on the processing result of the branch instruction, and is activated when the processing for the branch instruction has been completed.

The branch history table update section 22b predicts the next branch direction of a branch instruction, whose branch history stored in the branch history memory 21 has been updated, and updates the information of the branch history table 10 relating to the branch instruction, based on the predicted next branch direction.

Since the branch history table update section 22b updates the branch history table 10, using the branch prediction based on the branch history, similar branch prediction to that by the global history table can be carried out by the branch history table 10, thereby enabling improvement in the accuracy of branch prediction.

The branch history memory 21 will be explained now. FIG. 4 is a diagram which shows one example of data structure for entry to branch history memory 21. As shown in this figure, entry to the branch history memory 21 includes I-Address, Taken, N-Taken, Current, and Curr.Dir.

I-Address is an address of a branch instruction corresponding to this entry. The I-Address is not necessarily the whole address, and may be a partial bit string of the address, so long as this entry can be associated with the branch instruction.

Taken is the number of the recent continuous branching successful, and N-Taken is the number of the recent continuous branching failures. Curr.Dir is one-bit information indicating whether branch has been realized by the execution of the previous branch instruction. Current is the number of branching successful or failure shown in Curr.Dir, which occurs continuously until the execution of the previous branch instruction.

Specific examples of Taken, N-Taken and Current will be explained with reference to FIG. 5A and FIG. 5B. When Curr.Dir=0, it means that branching failure has occurred during execution of the previous branch instruction. When Curr.Dir=1 it means that branching has been realized successfully during execution of the previous branch instruction. “T” indicates branching successful, and “N” indicates branching failure, and the left direction indicates older branch history.

FIG. 5A shows one example of the branch history, when Curr.Dir=0. With recent two branch instructions, branching has been a failure continuously, and hence Current is equal to two. With six branch instructions prior to that, branching has been realized successfully continuously, and hence Taken is equal to six. With five branch instructions prior to that, branching has been a failure continuously, and hence N-Taken is equal to five.

FIG. 5B shows one example of the branch history, when Curr.Dir=1. With recent two branch instructions, branching has been realized continuously, and hence current is equal to two. With three branch instructions prior to that, branching has been a failure continuously, and hence N-Taken is equal to three. With six branch instructions prior to that, branching has been realized successfully continuously, and hence Taken is equal to six.

In this manner, by storing only the number of continuous recent branching successful and the number of branching failures as a branch history, the branch history can be stored efficiently, and hence the volume of hardware to be required can be reduced.

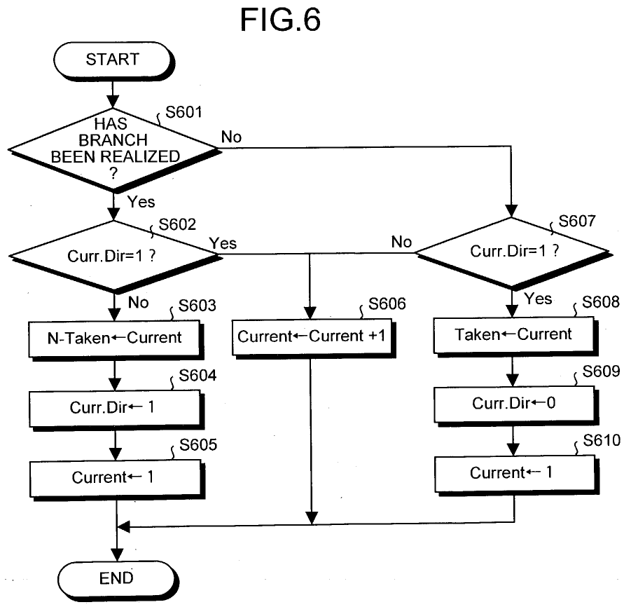

The procedure of branch history update processing by the branch history update section 22a will be explained in detail. FIG. 6 is a flowchart which shows the procedure of the branch history update processing by the branch history update section 22a. This branch history update processing is started at a point in time when the processing of the branch instruction has been finished.

As shown in FIG. 6, this branch history update section 22a checks if branching has been realized as a result of processing of the branch instruction (step S601). When the branching has been realized, it is checked whether Curr.Dir=1, that is, if branch has been realized when the branch instruction has been executed last time (step S602).

If branching has been a failure last time (i.e., “No” in step S602), branching is realized newly this time. Hence, the branch history update section 22a sets the value of Current, that is, the continuous number of branching failures up to now, to N-taken (step S603), changes Curr.Dir to branching successful (step S604), and initializes Current to 1 (step S605). On the other hand, if branch has been realized last time (i.e., “Yes” in step S602), branching successful is continued from the last time, and hence the branch history update section 22a adds 1 to Current (step S606).

As a result of processing of the branch instruction, if branch has been a failure (i.e., “No” in step S601), the branch history update section 22a checks if Curr.Dir=1, that is, if branch has been realized last time (step S607). If branch has been a failure last time, branching failures is continuous from the last time. Hence, the branch history update section 22a adds 1 to Current (step S606).

On the other hand, if branch has been realized last time (i.e., “Yes” in step S607), branching failure newly starts this time. Hence, the branch history update section 22a sets the value of Current, that is, the continuous number of branching successful up to now, to Taken (step S608), changes Curr.Dir to branching failure (step S609), and initializes Current to 1 (step S610).

The processing procedure when an entry with respect to a branch instruction exists in the branch history memory 21 has been explained herein, but if the entry with respect to the branch instruction does not exist in the branch history memory 21, this branch history update section 22a creates a new entry and registers it in the branch history memory 21.

In the created new entry, Current is set to 1, and when branch has been realized, Taken is set to an optional number, N-Taken is set to 0, and Curr.Dir is set to 1. When branch has been a failure, Taken is set to 0, N-Taken is set to an optional number, and Curr.Dir is set to 0.

When branch prediction is carried out, using the branch history, in the initial building stage of the branch history, since the historical data is not sufficient, the prediction often does not come true. Therefore, in the initial building stage of the branch history, update of the branch history table 10 based on the branch history in the branch history memory 21 should be avoided. Hence, when the value of Taken or N-Taken is 0, update of the branch history table 10 based on the branch history in the branch history memory 21 is not carried out.

The branch history update section 22a does not register an unconditional branch instruction and a branch instruction whose target is changed often in the branch history. The reason is that it is not necessary to predict a branch direction for the unconditional branch instruction, and as for a branch instruction whose target is changed often, even if only the branch direction is predicted, a target address cannot be predicted. Therefore, the number of entries registered in the branch history memory 21 can be reduced, as compared with the global history table, in which all branch instructions are registered. As a result, the volume of hardware to be required can be reduced.

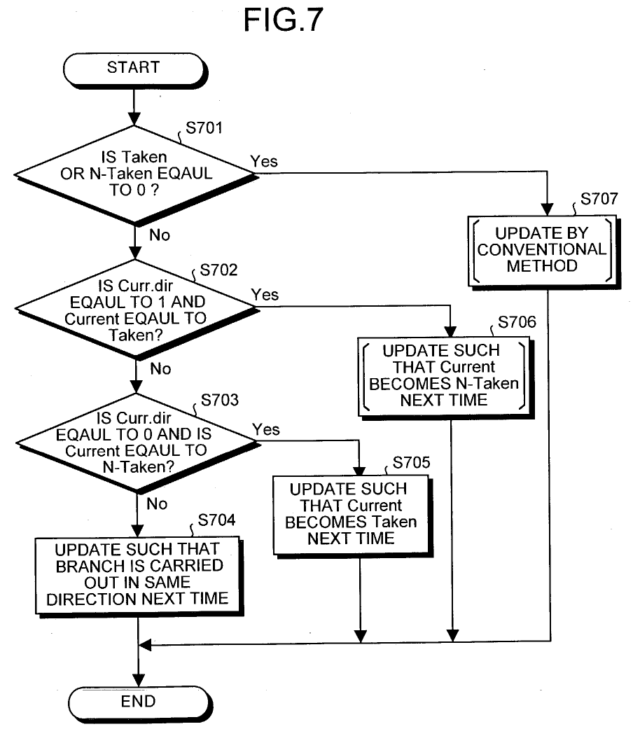

A procedure of branch history table update processing by the branch history table update section 22b will now be explained. FIG. 7 is a flowchart which shows the procedure of the branch history table update processing by the branch history table update section 22b. This branch history table update processing is started just after the branch history update processing shown in FIG. 6. However, if the branch history table 10 can be updated before the same branch instruction is processed next, this branch history table update processing may be started at a different timing.

As shown in FIG. 7, this branch history table update section 22b checks whether a branch history of a branch instruction whose update processing by the branch history update section 22a has been completed is in the initial building state, that is, whether the value of Taken or N-Taken in the entry, of which update processing has been carried out, is 0 (step S701). When the value of Taken or N-Taken is 0, the branch history table update section 22b updates the branch history table 10 by the conventional method (step S707), to thereby finish the processing.

On the other hand, when the value of Taken or N-Taken is not 0, the branch history table update section 22b checks if branch of a branch instruction whose processing has been finished is realized, and the number of continuous branching successful up to now agrees with the number of continuous branching successful last time, that is, Curr.Dir=1 and Current=Taken (step S702). When Curr.Dir=1 and Current=Taken, it indicates that branch has been a failure when this branch instruction has been executed next, last time. Therefore, the branch history table update section 22b updates the branch history table 10 so that the next branch prediction is a branching failure (step S706).

When Curr.Dir is not 1 and Current is not Taken, the branch history table update section 22b checks whether branch of the branch instruction whose processing has been finished is has been a failure, and the number of continuous branching failures up to now agrees with the number of continuous branching failures last time, that is, Curr.Dir=0 and Current=N-Taken (step S703). When Curr.Dir=0 and Current=N-Taken, it indicates that branch has been realized when this branch instruction has been executed next, last time. Therefore, the branch history table update section 22b updates the branch history table 10 so that the next prediction is branching successful (step S705).

On the other hand, when Curr.Dir is not 0 and Current is not N-Taken, it can be predicted that branch will occur next time in the same direction as that of this time. Therefore, the branch history table update section 22b updates the branch history table 10 so that the next prediction for the branch direction is the same as that of this branch result (step S704).

As described above, the branch history memory 21 stores a plurality of branch results in the past as a branch history for each branch instruction, and when processing of the branch instruction is finished, the branch history update section 22a updates the branch history in the branch history memory 21 corresponding to the branch instruction, based on the processing result, and the branch history table update section 22b updates the branch history table 10 based on the updated branch history. As a result, the prediction result using the branch history can be reflected in the branch history table 10 at the time of branching successful. Therefore, at the time of requesting instruction fetch, the range where the instruction fetch is to be carried out can be covered with the branch history table 10 having a sufficiently large capacity. Hence, even when the number of branch instructions that can be stored in the branch history memory 21 is very small, highly accurate prediction becomes possible, and hence highly accurate prediction can be performed at a low cost. Further, at the time of requesting instruction fetch, a complicated prediction processing is not necessary, enabling branch prediction at high speed.

According to the present invention, a plurality of branch results in the past of a branch instruction is stored as a branch history, and the branch direction of the branch instruction is predicted based on the stored branch history, and a table of correspondence of an address of the branch instruction and a predicted target address of the branch instruction is updated based on the predicted branch direction. Therefore, the prediction result obtained by using the branch history at the time of branching successful can be reflected in the branch history. As a result, at the time of requesting instruction fetch, the range where the instruction fetch is-to be carried out can be covered with the branch history having a sufficiently large capacity. Hence, even when the number of branch instructions stored in the branch history is very small, highly accurate prediction becomes possible, exhibiting such an effect that highly accurate prediction can be performed at a low cost. Further, at the time of requesting instruction fetch, a complicated prediction processing is not necessary, enabling branch prediction at high speed.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A branch prediction apparatus that predicts a target of a branch instruction using a branch history table, the branch history table storing a table of correspondence of an address of the branch instruction and a predicted target address of the branch instruction, the apparatus comprising:
a branch history storage unit that stores a branch history, the branch history containing branching results in the past due to the branch instruction; and
a branch history table update unit that predicts a branch direction of the branch instruction based on the branch history stored in the branch history storage unit, and updates the table of correspondence based on the predicted branch direction.

2. The branch prediction apparatus according to claim 1, wherein the branch history stored in the branch history storage unit is updated based on the processing result, at a point in time when the processing of the branch instruction has been finished.

3. The branch prediction apparatus according to claim 1, wherein the branch history storage unit refers to the branch history, by using the address of the branch instruction as an association key.

4. The branch prediction apparatus according to claim 1, wherein the branch history storage unit does not store an unconditional branch instruction in the branch history.

5. The branch prediction apparatus according to claim 1, wherein the branch history storage unit stores only an either-or branch instruction of whether the branch condition is realized, in the branch history.

6. The branch prediction apparatus according to claim 1, wherein the branch history storage unit stores the number of recent continuous branching successful and the number of recent continuous branching failures, for each branch instruction, and the branch history table update unit predicts branching successful or failure of the branch instruction, based on the number of recent continuous branching successful and the number of recent continuous branching failures.

7. The branch prediction apparatus according to claim 6, wherein the branch history table update unit predicts that branch will be a failure next time, when the number of continuous branching successful of the branch instruction immediately before is equal to the number of recent continuous branching successful, and predicts that branch will be realized next time, when the number of continuous branching failures of the branch instruction immediately before is equal to the number recent of continuous branching failures.

8. The branch prediction apparatus according to claim 6, further comprising a branch history building stage judgment unit that judges whether the branch history stored by the branch history storage unit is in an initial building state,
wherein the branch history table update unit does not update the table of correspondence, when the branch history is in the initial building state.

9. The branch prediction apparatus according to claim 8, wherein when the number of recent continuous branching successful or the number recent of continuous branching failures is 0, the branch history building stage judgment unit judges that the branch history is in the initial building state.

10. The branch prediction apparatus according to claim 1, wherein when the branch prediction of the branch instruction indicates a failure, the branch history table update unit does not register the branch instruction in the table of correspondence.

11. A branch prediction method of predicting a target of a branch instruction using a branch history table, the branch history table storing a table of correspondence of an address of the branch instruction and a predicted target address of the branch instruction, the method comprising:
a branch history update step of storing a plurality of branch results of the branch instruction in the past as a branch history, and updating the stored branch history, at a point in time when the processing of the branch instruction has been finished, based on the processing result; and
a branch history table update step of predicting a branch direction of the branch instruction based on the branch history updated at the branch history update step, and updating the table of correspondence based on the predicted branch direction.

12. The branch prediction method according to claim 11, wherein the branch history is an associative memory, which uses the address of the branch instruction as an association key.

13. The branch prediction method according to claim 11, wherein an unconditional branch instruction is not stored in the branch history.

14. The branch prediction method according to claim 11, wherein only an either-or branch instruction of whether the branch condition is realized is stored in the branch history.

15. The branch prediction method according to claim 11, wherein the number of recent continuous branching successful and the number of recent continuous branching failures are stored in the branch history, for each branch instruction, and at the branch history table update step, branching successful or failure of the branch instruction is predicted, based on the number of recent continuous branching successful and the number of recent continuous branching failures.

16. The branch prediction method according to claim 15, wherein at the branch history table update step, when the number of continuous branching successful of the branch instruction immediately before is equal to the number of recent continuous branching successful, it is predicted that branch will be a failure next time, and when the number of continuous branching failures of the branch instruction immediately before is equal to the number recent of continuous branching failures, it is predicted that branch will be realized next time.

17. The branch prediction method according to claim 15, further comprising a branch history building stage judgment step of judging whether the branch history is in an initial building state, and when the branch history is in the initial building state, the table of correspondence is not updated at the branch history table update step.

18. The branch prediction method according to claim 17, wherein at the branch history building stage judgment step, it is judged that the branch history is in the initial building state, when the number of recent continuous branching successful or the number recent of continuous branching failures is 0.

19. The branch prediction method according to claim 11, wherein when the branch prediction of the branch instruction indicates a failure, the branch instruction is not registered in the table of correspondence at the branch history table update step.
